(19) United States
(12) Patent Application Publication
(10) Pub. No.: US 2006/0170712 A1
(43) Pub. Date: Aug. 3, 2006

(54) Color display device with enhanced pixel pattern

(75) Inventors: Michael E. Miller, Honeoye Falls, NY (US); Paul J. Kane, Rochester, NY (US); Michael J. Murdoch, Rochester, NY (US); Dustin L. Winters, Webster, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/048,385

(22) Filed: Feb. 1, 2005

(51) Int. Cl. G09G 5/02

(52) U.S. Cl. 345/695

(57) ABSTRACT

A color display device is disclosed, comprising: an array of subpixels of three different colors, including subpixels of a relatively high luminance first color and subpixels of relatively lower luminance second and third colors, wherein the subpixels are arranged into rows or columns to form a repeating pattern of alternating lower luminance and high luminance color subpixels in each row or column, with the sequential order of the two lower luminance color subpixels being alternated within each row or column, and wherein the alignment of subpixels of the same colors in adjacent rows or columns is such that the high luminance color subpixels are aligned more closely to perpendicular than are each of the lower luminance color subpixels relative to the direction of the rows or columns in which the subpixels are arranged in a repeating pattern.

### FIELD OF THE INVENTION

The present invention relates to color display devices and, more particularly, to arrangements of subpixel elements in such color display devices.

### BACKGROUND OF THE INVENTION

Typical flat panel displays employ pixel patterns with red, green, and blue stripes. A portion of such a display device 2 is shown in FIG. 1. As shown in this figure, a pixel 4 contains red 6, green 8, and blue 10 subpixels. Neighboring pixels are positioned within a grid around this pixel such that they are aligned in rows and columns. This rectangular arrangement is important in many flat panel devices as each subpixel is addressed by horizontal or vertical select line 12, which selects a row or column of pixels to receive data as well as a data line 14, which is oriented perpendicular to the select line. In a bottom-emitting OLED display device, a power line 16 typically accompanies the data line. In an active matrix device, an inactive portion of the pixel is typically required to support transistors or other electronic components that form the connection between the select, data, and power lines, as well as connections to the anode and cathode that typically sandwich the emissive portion of the subpixel. The ratio of light emitting area to total area is referred to as the “fill factor”.

Applying the stripe pixel pattern shown in FIG. 1 allows the select, data, and power lines to be run in a rectilinear pattern between the subpixels, minimizing the length and therefore the area required for these lines and increasing the fill factor of the subpixels as compared to designs where these features of the display device are not straight lines.

It is also known in the art that when relatively large pixels are displayed on a small display or when graphics image regions are likely to be shown that demand a uniform appearance, alternating rows of light emitting subpixel elements may be offset horizontally to reduce the visibility of banding in a display device. Rows of alternating red, green and blue subpixels may be offset, e.g., to form an RGB “delta pattern”. Unlike the stripe pattern, this pattern reduces the visibility of banding and improves the uniform appearance in areas of constant color by shifting the alignment of the red, green, and blue subpixel elements in alternating rows. Unfortunately, this pattern also creates a visible jagged pattern in vertical lines containing primarily green light emitting subpixel elements as the human eye is very sensitive to offsets in light emitting subpixel elements that are high in luminance. Additionally, horizontally offsetting subsequent rows of pixels often results in a subpixel arrangement that does not form a column and typically forces the use of non-linear power and data lines, increasing the length of these lines and therefore the area between subpixels on the display device as well as the resistance of the lines. It is, however, known that in certain display structures, such as top-emitting, active-matrix OLED structures that the electronics may be placed on a different vertical layer, allowing the electronics to reside under the subpixel and reducing the impetus for the pixels to be laid out in a rectilinear grid.

It has been known for many years that the human eye is most sensitive to greenish-yellow light and less sensitive to red and blue light. More importantly, the spatial resolution of the human visual system is driven primarily by the luminance rather than the chrominance of a signal. Since green light provides the preponderance of luminance information in a display device employing red, green and blue subpixels when viewed in typical viewing environments, the spatial resolution of the visual system under normal daylight viewing conditions is highest for green light, lower for red light, and even lower for blue light when viewing images generated by a typical color balanced image capture and display system. This fact has been used in a variety of ways to optimize the frequency response of imaging systems.

It is further known in the art to employ different numbers of red, green, and blue subpixels within a repeating pattern of a display device in order to improve the perceived image quality of the display device for a given number of subpixels. In published papers, Rogowitz in 1988 (The psychophysics of spatial sampling in the Society of Photographic and Instrumentation Engineers, Vol. 901, Image Processing, Analysis Measurement and Quality, pp. 130-138) and later Silverstein and colleagues in 1990 (Effects of spatial sampling and luminance quantization on the image quality of color matrix displays in the Journal of the Optical Society of America, Vol. 7, No. 10, pp. 1955-1968) described the use of a four element pattern having two green, one blue and one red subpixel per pixel as shown in FIG. 2 where each subpixel was of equal size. The use of pixel patterns employing fewer of one color subpixel than another color subpixel is referred to as subsampling. As shown in this figure, a display device 20 has a pixel 22 composed of one red 24, one blue 30 and two green 26 and 28 subpixels per pixel, all of which are arranged as four equal sized squares to form a pixel.

A particularly noteworthy advantage of this pixel pattern is that because the red and blue subpixels are offset from each other on a diagonal axis, each of the three sets of color emitters has an equal sampling lattice in the horizontal and vertical axes. Therefore, the largest horizontal or vertical separation 32 between any two neighboring subpixels is only one subpixel plus the inactive area between the subpixels. This is important since if this separation is large, banding or dithering-like artifacts may be visible in any flat field within an image.

One disadvantage of the pattern shown in FIG. 2 is that the horizontal and vertical dimensions of the four subpixels are all equal and the relative areas of the four subpixels can not easily be adjusted independently of one another while maintaining the same inactive area between each subpixel. This attribute of this pattern presents many design challenges since the relative areas of each color of subpixel may affect the color balance of a display device in display devices employing light modulators, such as liquid crystal displays (LCDs), or the lifetime of a display device in display devices employing emissive technologies, such as organic light emitting diodes (OLEDs). Therefore, the color balance of display devices employing light modulators is often controlled by having equal or near equal areas of the three colors while the lifetime of emissive devices are often controlled by selecting an area for each colored emitter which equalizes the lifetime of all three emitters. For example, it is known to provide an OLED display having pixels with differently sized red, green and blue light emitting subpixel elements, wherein the relative sizes of the subpixel elements in a pixel are selected to extend the service life of the display. See, e.g., U.S. Pat. No. 6,366,025 B1, issued Apr. 2, 2002 to Yamada. Using OLED materials that are known today, this design constraint typically requires the use of larger areas of red and/or blue light emitting elements than green light emitting elements, providing a design constraint that is counter to increasing the area of the green light emitting area as would occur if one were to employ the pattern shown in FIG. 2. To form the pixel to maximize the display device lifetime in an OLED display device, one would need to substantially reduce the relative area of the two green subpixels with respect to the area of the red and blue subpixels. Using the pixel pattern shown in FIG. 2 requires the select, power and/or data lines to be routed along a non-rectilinear grid pattern if the select, power and data lines are required to run through the pixel and the relative area of the red and blue subpixels are increased relative to the green subpixel by reducing the length or height of the green subpixel while increasing the length or height of the red and blue subpixels.

A second disadvantage of this pixel pattern is that the subpixels are relatively large in both the horizontal and vertical dimensions as compared to other potential pixel patterns, such as the stripe pattern shown in FIG. 1, which has narrow vertical stripes. This is important, especially where the exact pixel pattern is repeated both horizontally and vertically, since the pattern can again exhibit banding in flat fields of a single color if the smallest dimension of one colored subpixel and the inactive area surrounding it is large enough to be perceived by the human eye.

A third disadvantage is that this pixel pattern may require additional power and/or data lines, if the data and power lines provide only data and power to a single colored subpixel as is the case in traditional displays.

Other pixel patterns with fewer red and blue subpixels have been discussed by Credelle (U.S. patent application 2004/0080479 filed on Jan. 16, 2003 and entitled “Sub-pixel arrangements for striped displays and methods and systems for sub-pixel rendering same”) who discusses an arrangement of stripe pixel patterns having two subpixels of one color (typically green) and one subpixel each of a second and third color (typically red and blue). One such pixel pattern is shown in FIG. 3. As shown, the display device 34 is composed of an array of pixels, wherein each pixel 36 is composed of one red subpixel 38, two green subpixels 40 and 44 and one blue subpixel 42. As with the stripe pattern, this arrangement of subpixels provides a rectilinear grid to allow the horizontal select lines 46 to be laid out perpendicular to the data 48 and power 50 lines of the display. While this pixel pattern takes advantage of the fact that the eye is less sensitive to spatial information in the blue and red channel than to spatial information in the green channel, it provides a relatively large horizontal separation 52 between neighboring red or blue subpixels as compared to the pixel pattern shown in FIG. 2. As noted earlier, if this separation is too large, significant banding artifacts may be introduced into the image. In fact, this banding artifact will be readily visible in imaging devices that are manufactured using pixel resolutions that are available in mass production today.

It is also worth noting that Credelle (U.S. patent application 2004/0080479) also discusses methods for resampling the input data to the particular subpixel arrangement that is provided. In the approach provided by Credelle, a 3×3 matrix, or filter kernel, is convolved with the input data. A disadvantage of this technique is that it requires 3 rows of data to be buffered in peripheral or external memory or controlling circuitry such that data for the preceding and following rows are available to perform this convolution. For small portable devices, this requirement may add complexity and cost while also increasing the power demands for the final ASIC.

There is a need, therefore, for an improved pixel pattern for color display devices that takes advantage of the eye's relative inability to sense high spatial frequency information in both the red and blue channels in comparison to higher luminance channels, such as the green channel of a display, and to reduce the overall number of subpixels required to obtain a desired display quality wherein regions of uniform color appear uniform and are not degraded by visible banding or dithering-like patterns due to the scarcity of the sampling pattern. Such a pattern should improve the uniformity of a pattern and yet avoid the visibility of jagged vertical or horizontal lines. Further, it would be desirable for such pixel pattern to allow the areas of the subpixels to be adjusted independently of one another while ideally providing a rectangular grid for the routing of select, power, and data lines. Finally, it would be further desirable for such a pixel pattern to allow a less complex approach to resampling that does not require multiple rows of data to be buffered.

### SUMMARY OF THE INVENTION

In accordance with one embodiment, the invention is directed towards a color display device, comprising: an array of subpixels of three different colors, including subpixels of a relatively high luminance first color and subpixels of relatively lower luminance second and third colors, wherein the subpixels are arranged into rows or columns to form a repeating pattern of alternating lower luminance and high luminance color subpixels in each row or column, with the sequential order of the two lower luminance color subpixels being alternated within each row or column, and wherein the alignment of subpixels of the same colors in adjacent rows or columns is such that the high luminance color subpixels are aligned more closely to perpendicular than are each of the lower luminance color subpixels relative to the direction of the rows or columns in which the subpixels are arranged in a repeating pattern.

### ADVANTAGES

In accordance with various embodiments of the invention, the use of pixel patterns with fewer relatively lower luminance color subpixels than relatively high luminance color subpixels (e.g., fewer red and blue subpixels than green subpixels) is enabled while providing a uniform appearance in regions of solid primary or secondary colors. The various embodiments further improve the uniformity of a pattern and yet decrease the visibility of jagged vertical or horizontal lines. Further, in preferred embodiments the pixel pattern will provide the flexibility of resizing the relative areas of the different color subpixels to provide display color balance and/or extend the lifetime of the display device. Further, the pixel patterns in various embodiments allow red and blue subpixels to share data and power lines, simplifying panel layout and potentially improving pixel fill factor. Additionally while data resampling methods known in the art may be applied to avoid certain sampling artifacts that can result with subsampling, these pixel patterns allow the reduction of these artifacts when resampling is not applied in order to simplify the processing of the input signal. Finally, many of the pixel patterns allow the use of a rectilinear grid for routing of data select, data and power lines.

### BRIEF DESCRIPTION OF THE DRAWINGS

FIG. 1 is a schematic diagram showing an arrangement of subpixels forming four pixels in a stripe arrangement (prior art).

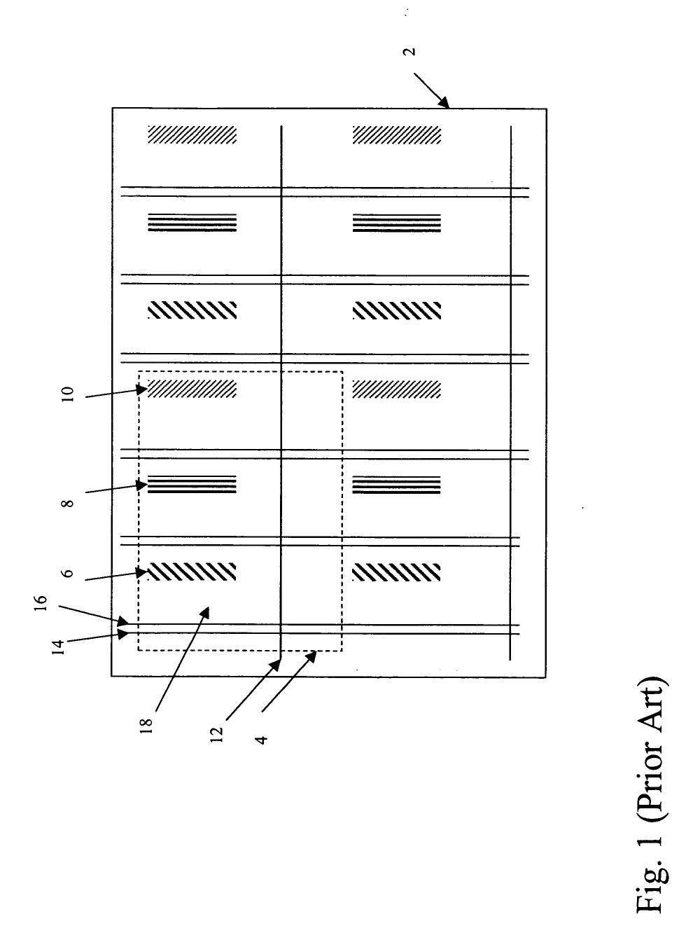

FIG. 2 is a schematic diagram showing an arrangement of subpixels forming four pixels in a quad arrangement wherein there are two green subpixels and one red and blue subpixel per pixel (prior art).

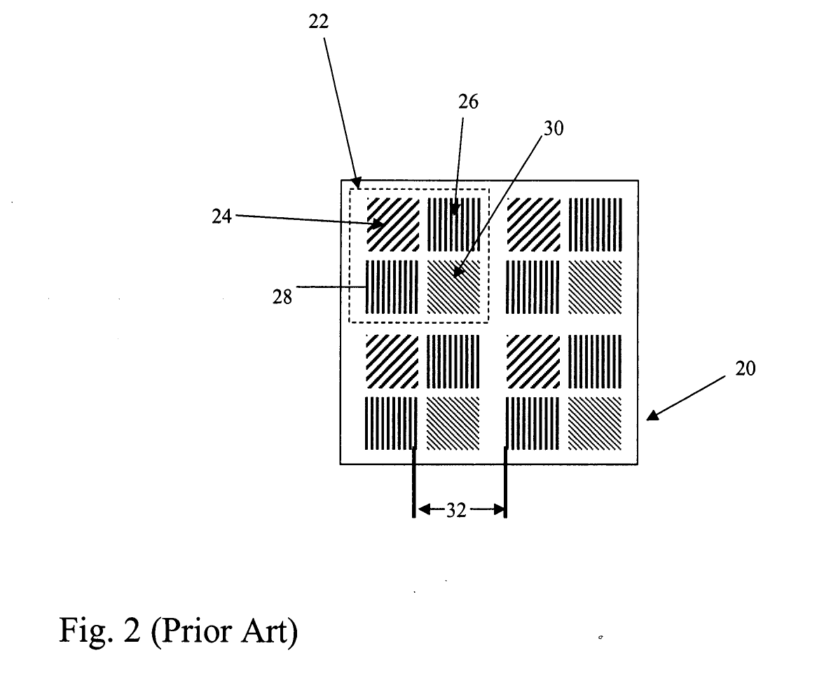

FIG. 3 is a schematic diagram showing an arrangement of subpixels forming four pixels in a stripe arrangement wherein there are two green subpixels and one red and blue subpixel per pixel (prior art).

FIG. 4 is a schematic diagram showing an arrangement of subpixels forming four pixels according to one embodiment of the present invention.

FIG. 5 is a schematic diagram showing an arrangement of subpixels forming four pixels in which different red and blue subpixel areas are required according to embodiment of the present invention.

FIG. 6 is a circuit diagram depicting the layout of a circuit useful in driving an OLED display device having a pixel arrangement in which different red and blue subpixel areas are required according to an embodiment of the present invention.

FIG. 7 is a layout diagram, depicting the layout of an OLED display device having a pixel arrangement according to an embodiment of the present invention in which different red and blue subpixel areas are required.

FIG. 8 is a schematic diagram depicting a cross section of an OLED display useful in practicing this embodiment within this display technology.

FIG. 9 is a schematic diagram showing an arrangement of subpixels forming four pixels in an offset stripe arrangement according to one embodiment of the present invention.

FIG. 10 is a schematic diagram showing an arrangement of non-rectangular subpixels forming four pixels according to one embodiment of the present invention.

FIG. 11 is a schematic diagram showing an arrangement of non-rectangular subpixels forming four pixels according to one embodiment of the present invention wherein the red, green and blue subpixel areas are unequal.

FIG. 12 is a flow chart of a method for determining the drive values for the lower luminance subpixels.

FIG. 13 is a schematic diagram showing a two-dimensional representation of the assumed sampling grid of the input data and the overlaid sampling grid of neighboring, lower luminance subpixels.

FIG. 14 is a schematic diagram showing a one-dimensional representation of the assumed sampling grid of the input data and the overlaid sampling grid of neighboring lower luminance subpixels.

### DETAILED DESCRIPTION OF THE INVENTION

In accordance with various embodiments described herein, the invention is directed towards a color display device, comprising: an array of subpixels of three different colors, including a first relatively high luminance color and two relatively lower luminance colors, wherein the subpixels are arranged into rows or columns to form a repeating pattern of alternating lower luminance and high luminance color subpixels in each row or column, with the sequential order of the two lower luminance color subpixels being alternated within each row or column. Thus, due to the two lower luminance color subpixels being alternated in sequence with the single high luminance color subpixel, there are more high luminance color subpixels than lower luminance subpixels of a single color, and the lower luminance colors are subsampled relative to the high luminance color. Further in accordance with the invention, the alignment of subpixels of the same colors in adjacent rows or columns is such that the high luminance color subpixels are aligned more closely to perpendicular than are each of the lower luminance color subpixels relative to the direction of the rows or columns in which the subpixels are arranged in a repeating pattern. Pixel patterns meeting such requirements are designed to reduce the maximum separation between the lower luminance subpixels while maintaining the high luminance color subpixels in relative perpendicular alignment, by providing pixels having more than one subpixel arrangement in neighboring pixels.

Experiments conducted by the inventors have shown that when displaying patterns with red and blue subsampling, as known in the prior art, on a display device at resolutions typical of manufacturing today, banding or dithering artifacts are readily apparent when primary and/or secondary colors are displayed. Further experiments have demonstrated that if the sampling lattice of the pattern is designed such that neighboring subpixels of any given color are separated by less than one minute of arc, the visibility of the banding or dithering is significantly reduced and, in fact, may be essentially eliminated if the separation is significantly less than a visual angle of one minute of arc. This result is surprising since it is to be expected that a 100 percent contrast white target on a display could be resolved at this resolution, however, the visual system would typically be assumed to be less responsive to targets of lower brightness and therefore lower contrast than the white point of the display. Further, the experiments conducted by the authors have demonstrated that the maximum of the horizontal and vertical distance between neighboring pairs of subsampled, lower luminance subpixels can be reduced through the use of different subpixel arrangements in neighboring pixels. These different arrangements can be achieved by alternating the location of lower luminance subpixels on alternating rows or columns of pixels and/or by offsetting the subpixels in successive rows or columns of pixels. This distance may be further reduced through the use of non-rectilinear subpixel shapes, such as triangles, that produce overlaps in the horizontal and/or vertical dimension. By requiring that the alignment of subpixels of the same colors in adjacent rows or columns is such that the high luminance color subpixels are aligned more closely to perpendicular than are each of the lower luminance color subpixels relative to the direction of the rows or columns in which the subpixels are arranged in a repeating pattern, the maximum of the horizontal and vertical distance between neighboring pairs of subsampled, lower luminance subpixels can be minimized while maintaining the high luminance color pixels in relative perpendicular alignment, thus decreases the visibility of jagged vertical or horizontal lines.

Within this document the term “subpixel” represents the smallest individually addressable element in a display device. The term “pixel” is applied to represent an arrangement of neighboring subpixels containing two, higher-luminance subpixels and two lower-luminance subpixels wherein the two lower-luminance subpixels have different colors. The term “data location” is applied to represent a theoretical location in which a set of input code values would be rendered on a traditional, fully-sampled, three-color display system.

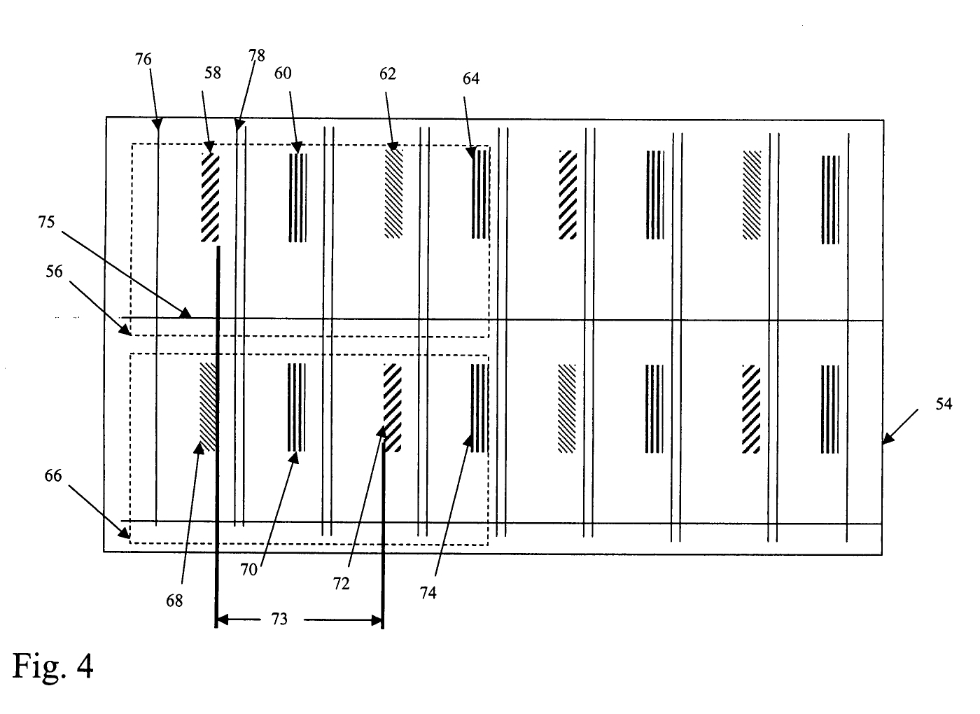

In one embodiment of the present invention, alternating horizontal rows of pixels in the display comprise a first pixel type wherein the subpixels are positioned in a sequence of relatively lower luminance second color, relatively high luminance first color, relatively lower luminance third color, and relatively high luminance first color subpixels, where the sequence of subpixels in the alternating rows of pixels is repeated across the width of the display, while interleaving horizontal rows of pixels between the alternating rows in the display comprise a second pixel type wherein the subpixels are positioned in a sequence of relatively lower luminance third color, relatively high luminance first color, relatively lower luminance second color, and relatively high luminance first color subpixels, where the sequence of subpixels in the interleaving rows of pixels also is repeated across the width of the display, and where the sequences of subpixels in alternating and interleaving rows repeat across the height of the display. In such arrangement, the subpixel types on one row may be arranged to form a repeating pattern of lower luminance and higher luminance subpixel types in a stripe arrangement while the order of the lower luminance subpixels are altered on the successive row as shown in FIG. 4.

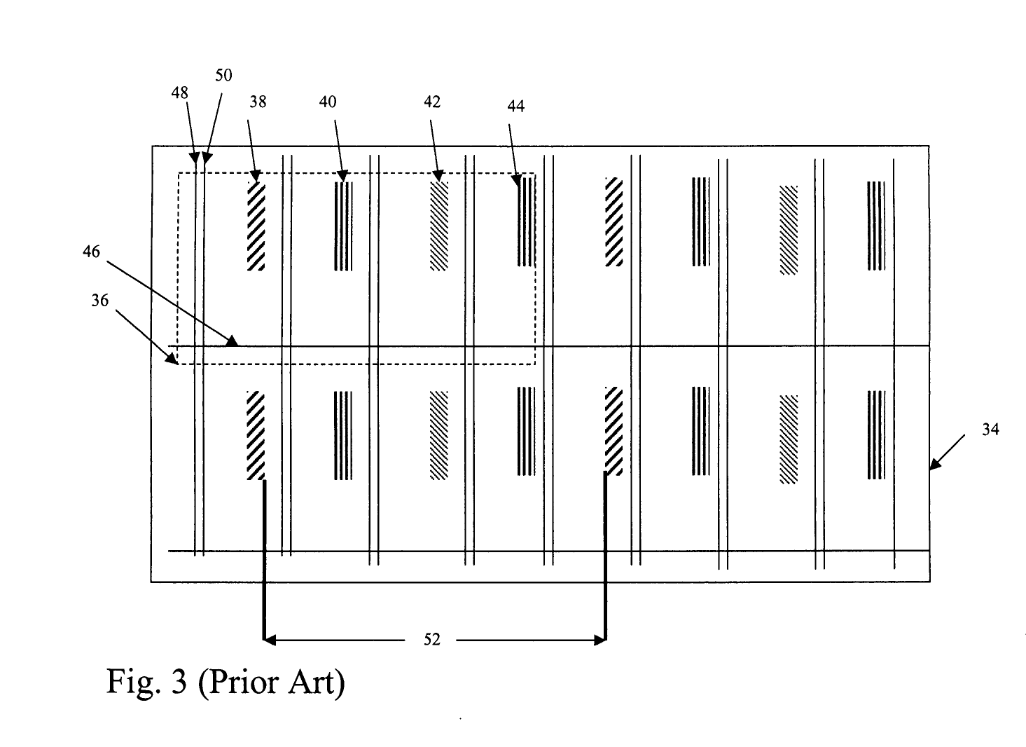

As shown in FIG. 4, the display device 54 is composed of an array of pixels in a row, each pixel 56 in the row is composed of two lower luminance subpixels of different color, red 58 and blue 62 subpixels, and two higher luminance subpixels of one color, green subpixels 60 and 64, in a repeating fashion. Thus, the pixel pattern has two lower luminance subpixel types and one higher luminance subpixel type and provides fewer lower luminance subpixels of each type than higher luminance subpixels to provide a subsampled pixel pattern. A successive row is composed of an array of pixels 66 wherein the location of the red 72 and blue 68, lower luminance subpixels are interchanged with respect to the first pixel 56 while the location of the two higher luminance green subpixels 70 and 74 are maintained within the pixel. By interchanging the locations of the two lower luminance subpixels within this subsampled pixel pattern, the maximum of the horizontal and vertical distances 73 between two neighboring lower luminance subpixels of each color is reduced as compared to the maximum of the horizontal and vertical distances 52 between subpixels of each color of the prior art stripe pattern shown in FIG. 3. Within a display panel of this embodiment, these two rows of pixels are repeated along one dimension of the display device while the two columns of pixels are repeated along the perpendicular dimension of the display device. In the particular embodiment of FIG. 4, alternating horizontal rows of pixels in the display comprise a first pixel type wherein the subpixels are positioned in a sequence of red, green, blue and green rectangular shaped subpixels, whose long axes are oriented vertically, and whose long axes are parallel to each other, and the interleaving horizontal rows of pixels between the alternating rows in the display comprise a second pixel type wherein the subpixels are positioned in a sequence of blue, green, red and green rectangular shaped subpixels, whose long axes are oriented vertically, and whose long axes are parallel to each other.

An arrangement such as this may be particularly desirable because the higher luminance elements are aligned vertically, perpendicular to the horizontal rows. This fact is important since vertical lines within text characters and other high-contrast, vertically-oriented edges will appear “jagged” (i.e., have a sawtooth pattern appearance) if these high contrast subpixels are not vertically aligned. The fact that the location of the red and blue subpixels are interchanged with each successive row of subpixels, and that the alignment of the red and blue subpixels of the same colors in adjacent rows or columns is accordingly further from perpendicular than that of the high luminance green subpixels, decreases the maximum of the vertical and horizontal distance between neighboring subpixels of these color channels and improves the overall uniformity when flat fields of red and blue colors are displayed while maintaining the desired relative perpendicular alignment of the green pixels.

It should additionally be noted that a single data 76 and power line 78 may be used to provide connections to both a red 58 and a blue 68 subpixel within this pixel arrangement. As will be discussed later, processing to provide the correct voltage and current to each subpixel is performed on the input data signal to enable the data line 76 to be shared by both red 58 and blue 68 subpixels. The fact that a common data line shares red and blue subpixels while a second data line is used to drive the only high luminance subpixel also allows data to be communicated to the display using two input channels. This has the effect of reducing the number of output channels that must be supported by a display processor (e.g., asic) from three to two. This not only reduces the complexity of the processor but also reduces the power required to drive the analog output channels of the processor.

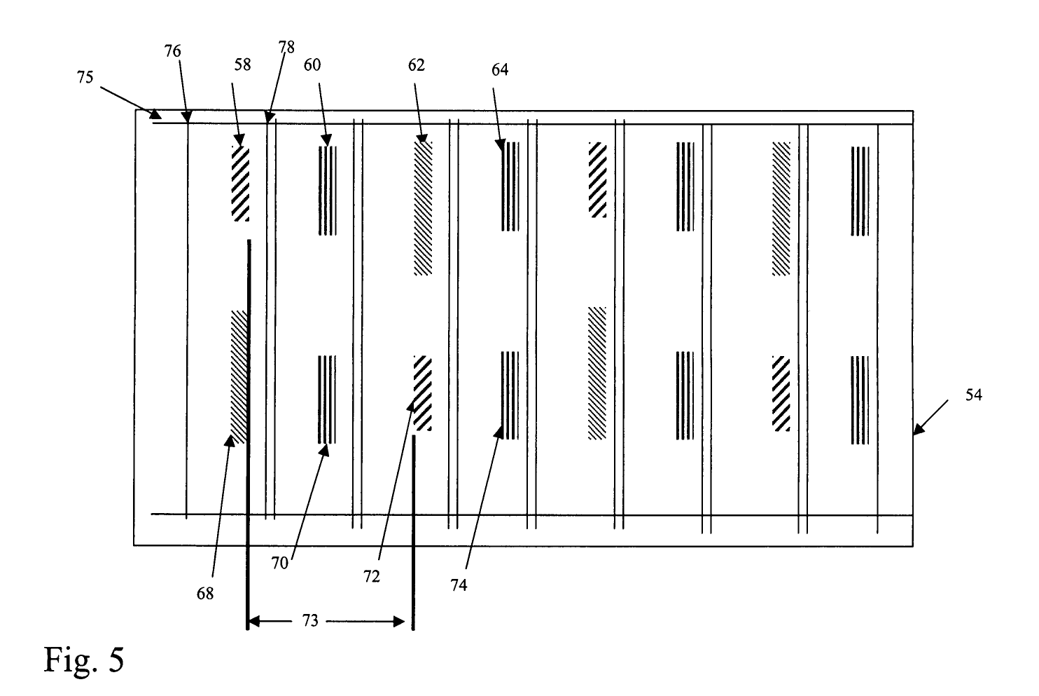

Within this pixel pattern, it is important to note that the relative areas of the subpixels can be adjusted. The active area of the green subpixel can be adjusted by simply changing the horizontal width of the subpixel. The relative areas of the red and blue subpixels with respect to the active area of the green subpixel may be adjusted using the same method. Note that the relative areas of the red and blue subpixels, however, can not be easily adjusted relative to one another by adjusting their horizontal widths without making one wider than another, resulting in a larger inactive area than necessary or a non-rectilinear grid. With care, however, the relative heights of these subpixels can be adjusted. FIG. 5, e.g., shows another version of this pixel pattern in which the relative heights of the red subpixels 58 and 72 have been reduced while the relative heights of the blue subpixels 62 and 68 have been increased. In this layout, the horizontally-oriented select line 75 may be relocated from between the two rows of subpixels to above the two rows of subpixels as is shown in FIG. 5.

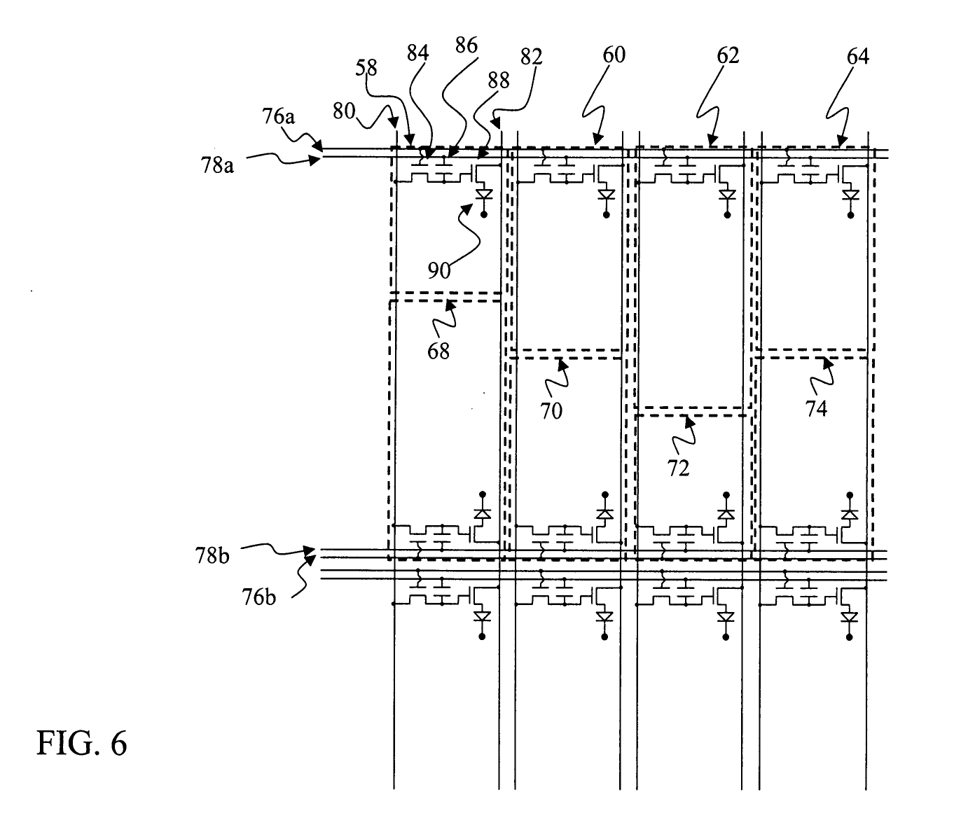

While such a pixel pattern may be useful for any display technology, it may be particularly useful in OLED display applications since it is known to be desirable to allocate different areas to the different colored light emitting elements in order to optimize their lifetime. For this reason, FIGS. 6, 7, and 8 show a more detailed embodiment of this pixel pattern for use in an OLED display. Turning now to FIG. 6, there is shown a circuit pattern diagram according to one embodiment of the present invention. The display is a three-color OLED display that is formed from a plurality of subpixels such as subpixels 58, 60, 62, 64, 68, 70, 72, and 74. FIG. 6 shows active matrix drive circuitry that may be used to drive the display. The drive circuitry is composed of signal lines such as select line 76a, select line 76b, capacitor line 78a, capacitor line 78b, data line 80, and power line 82. These signal lines are common to row or columns of subpixels as shown. The active matrix drive circuitry further comprises components such as select transistor 84, power transistor 88, and storage capacitor 86, which together with one or more of the signal lines are arranged to drive the organic light emitting diode 90 of subpixel 58. The other subpixels are provided with similar components to drive their respective organic light emitting diodes. A common top electrode connection (not shown) is connected to cathodes of all the organic light emitting diodes to complete the circuit.

The subpixels are arranged in a matrix of rows and columns. That is, for example, subpixel 58 and subpixel 60 are arranged in a first row. Select line 76a and capacitor line 78a are shared by the subpixels in this first row. Subpixel 68 and subpixel 70 are arranged in a second row. Select line 76b and capacitor line 78b are shared by the subpixels in this second row. Subpixel 58 and subpixel 68 are arranged in a first column. Data line 80 and power line 82 are shared by the subpixels in this first column. While only a limited number of rows and columns are shown, this design can be expanded to provide for a plurality of rows and columns. Alternate arrangements can also be practiced. For example, two adjacent columns may share the power line. Alternately, the power line may be run in the same row direction instead of the column direction and be shared by the subpixels of the row. Also, other more complex subpixel circuits having more transistors in various arrangements are known in the art and can also be applied to the present invention by one skilled in the art.

The drive circuitry operates in a manner well known in the art. Each row of subpixels is selected by applying a voltage signal to the select line, such as select line 76a, which turns on a select transistor, such as select transistor 84, for each subpixel. The brightness level for each subpixel is controlled by a voltage signal, which has been set on the data lines such as data line 80. The storage capacitor, such as storage capacitor 86, for each subpixel is then charged to the voltage level of the data line associated with that subpixel and maintains the data voltage until the row is selected again during the next image frame. The storage capacitor 86 is connected to the gate of the power transistor 88 so that the voltage level held on storage capacitor 86 regulates the current flow through the power transistor 88 to the organic light emitting diode 90 and thereby controls the subpixel's brightness. Each row is then un-selected by applying a voltage signal to the select line, such as 76a, which turns off the select transistors. The data line signal values are then set to the levels desired for the next row and the select line of the next row, for example 76b, is turned on. This is repeated for every row of subpixels.

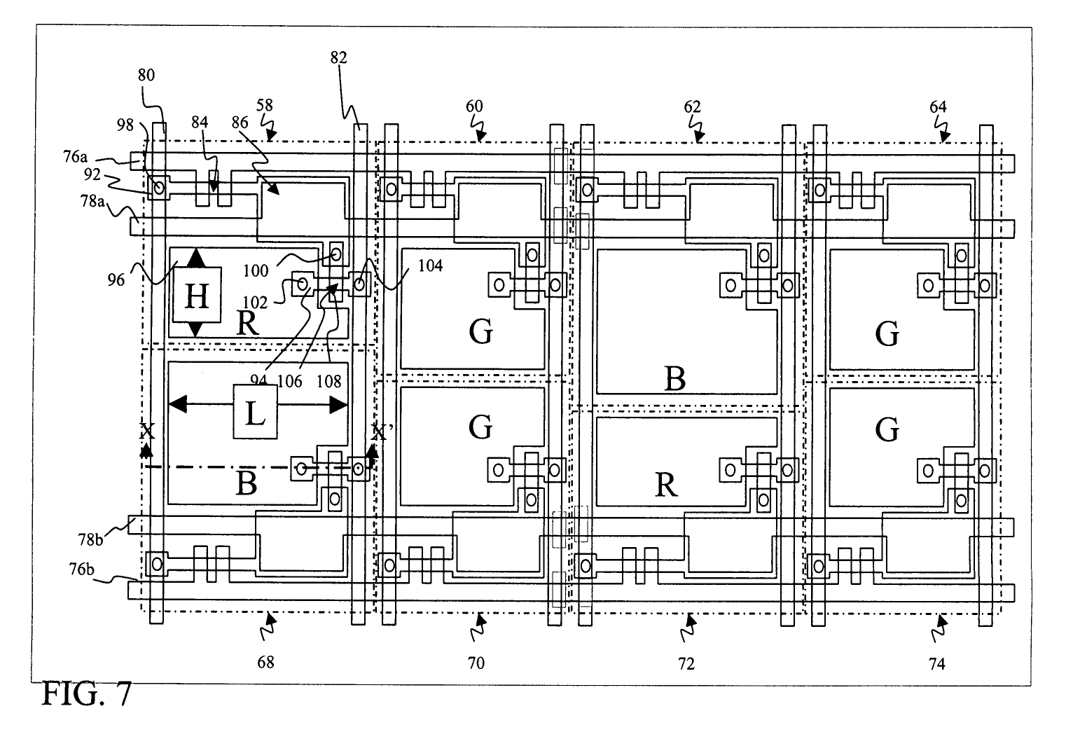

A layout diagram for the portions of the drive circuitry used to drive subpixels 58, 60, 62, 64, 68, 70, 72, and 74 is shown is shown in FIG. 7. Note that FIG. 7 has been stretched horizontally to provide more room for numbering. For this reason, the subpixels appear to be nearly square, rather than rectangles with their long direction oriented in the same direction as the column of subpixels. FIG. 7 shows the construction of the various circuit components such as select transistor 84, storage capacitor 86, and power transistor 106. The drive circuitry components are fabricated using conventional integrated circuit and thin film transistor fabrication technologies. Select transistor 84 is formed from a first semiconductor region 92 using techniques well known in the art. Select transistor 84 is shown as a double gate type transistor, however, this is not required for successful practice of the present invention and a single gate type transistor could also be used. Similarly, power transistor 106 can be formed in a second semiconductor region 94. The first semiconductor region 92 and second semiconductor region 94 are typically formed in the same semiconductor layer. This semiconductor layer is typically silicon and is preferably polycrystalline or crystalline, but can also be amorphous. This first semiconductor region 92 also forms one side of storage capacitor 86. Over the first semiconductor region 92 and second semiconductor region 94 is an insulating layer (not shown) that forms the gate insulator of select transistor 84, the gate insulator for power transistor 106, and the insulating layer of storage capacitor 86. The gate of select transistor 84 is formed from part of select line 76a, which is formed in the first conductor layer. Power transistor 106 has a separate power transistor gate 108 also preferably formed in the first conductor layer. The other electrode of storage capacitor 86 is formed as part of capacitor line 78a, also preferably formed from the first conductive layer. Power line 82 and data line 80 are preferably formed from a second conductive layer. One or more of the signal lines (e.g. select line 76a) frequently cross at least one or more of the other signal lines (e.g. data line 80), which requires these lines to be fabricated from multiple conductive layers with at least one interlayer insulating layer (not shown) in between. The first electrode 96 of the organic light emitting diode is connected to power transistor 108. An insulating layer (not shown) is located between the first electrode 96 and the second conductive layer.

Connections between layers are formed by etching holes (or vias) in the insulating layers such as via 98 connecting data line 80 to the first semiconductor region 92. Similarly, via 100 connects the power transistor gate 108 to first semiconductor region 92, via 104 connects the second semiconductor region 94 to power line 82, and the via 102 connects the second semiconductor region 94 the first electrode 96.

First electrode 96 serves to provide electrical contact to the organic electroluminescent media of the organic light emitting diodes. Over the perimeter edges of the first electrode 96, an intersubpixel dielectric layer (not shown) may be formed to cover the edges of said electrodes and reduce shorting defects as described below. The emitting area of subpixel 58 is defined by the areas of the first electrode 96 which is in electrical contact with the organic electroluminescent media. This emitting area is the area of the first electrode 96 reduced by any area covered by dielectric material.

Each of the differently colored subpixels can have different efficiencies and lifetimes. Therefore, the emitting area for each differently colored subpixel will be optimized differently. Several approaches to optimizing the emitting area are known in the art, examples of which can be found in U.S. Pat. Nos. 6,366,025 and 6,747,618.

The emitting areas of the subpixels can be adjusted without bending of any of the signal lines by adjusting the size of the emitting area in the column direction, or height (H), or adjusting the size of the emitting area in the row direction, or width (W). By disposing select line 76a and select line 76b on the outside of their associated subpixels, different heights of the subpixel emitting areas can be achieved for subpixels in the same row, as shown. That is pixels 58, 60, 62, 64, 68, 70, 72, and 74 are disposed between select line 76a and select line 76b, allowing the select lines to be formed in a straight, unbending, fashion. For pixels in the same column, these pixels may generally have the same width. These heights and widths are thereby balanced so that each different colored pixel has the desired emitting area. It is not necessary that the subpixel emitting areas be perfectly rectangular, as irregularities in the emitting areas, as shown, may be provided to conform to the areas of the circuit components, such as the transistors.

One or more of the subpixels may further include a color filter element (not shown) to alter the spectrum of the emitted light of the subpixel. The color filter elements may be disposed between the organic electroluminescent media and the viewer.

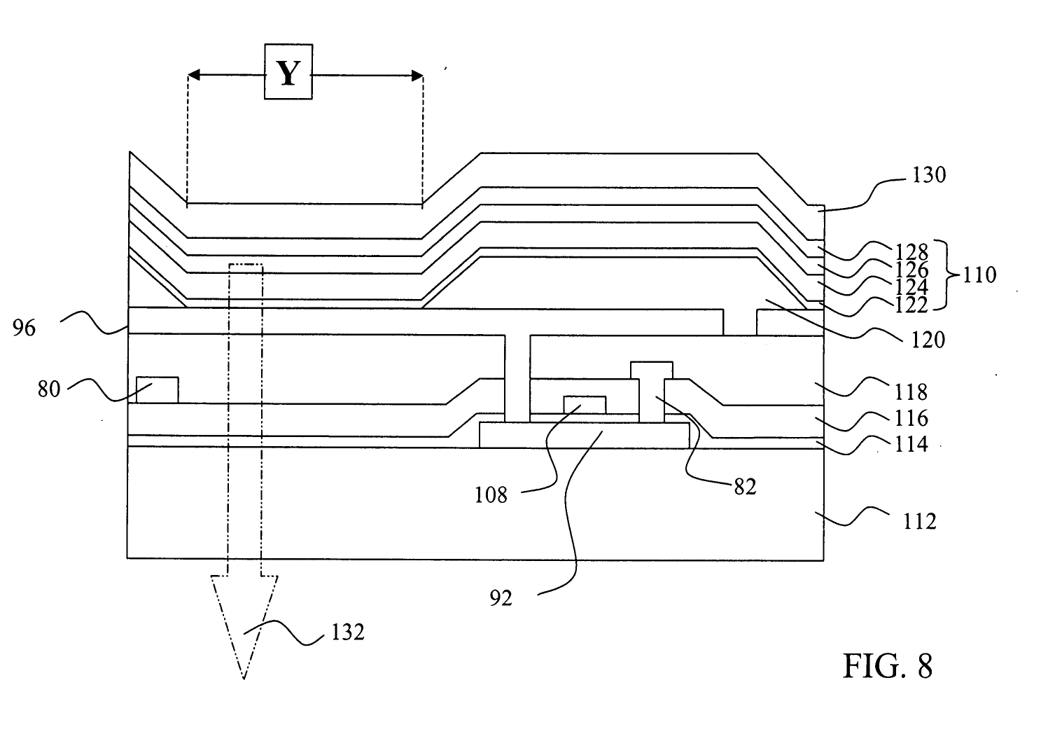

A cross-sectional view illustrating the vertical arrangement of the various layers of the device of FIG. 7 along line X-X′ is shown in FIG. 8. The device including the drive circuitry and the organic EL media 110 are formed on substrate 112. Many materials can be used for substrate 112 such as, for example, glass and plastic. The substrate may be further covered with one or more barrier layers (not shown). If the device is intended to be operated such that light generated by the subpixels is viewed through the substrate, the substrate should be transparent. This configuration is known as a bottom-emitting device. In this case, materials for the substrate such as glass or transparent plastics are preferred.

Above the substrate 112, a first semiconductor layer is provided, from which semiconductor region 92 is formed. Above semiconductor region 92, first dielectric layer 114 is formed and patterned by methods such as photolithography and etching. This dielectric layer is preferably silicon dioxide, silicon nitride, or a combination thereof. It may also be formed from several sub-layers of dielectric material. Above first dielectric layer 114, a first conductor layer is provided, from which power transistor gate 108 is formed and patterned by methods such as photolithography and etching. This conductor layer can be, for example, a metal such as Cr, as is known in the art. Above power transistor gate 108, a second dielectric layer 116 is formed. This dielectric layer can be, for example, silicon dioxide, silicon nitride, or a combination thereof. Above second dielectric layer 116, a second conductor layer is provided, from which power line 82 and data line 80 are formed and patterned by methods such as photolithography and etching. This conductor layer can be, for example, a metal such as an Al alloy as is known in the art. Power line 82 makes electrical contact with semiconductor region 92 through a via opened in the dielectric layers. Over the second conductor layer, a third dielectric layer 118 is formed.

Above the third dielectric layer, a first electrode 96 is formed. First electrode 96 is preferably highly transparent for the case of a bottom-emitting configuration and may be constructed of a material such as ITO. Above first electrode 96, an inter-subpixel dielectric 120 layer, such as is described in U.S. Pat. No. 6,246,179, is preferably used to cover the edges of the first electrodes in order to prevent shorts or strong electric fields in this area. While use of the inter-subpixel dielectric 120 layer is preferred, it is not required for successful implementation of the present invention. As described previously, the area of the first electrode 96 not covered by inter-subpixel dielectric 120 constitutes the emitting area and is represented on the this cross-section view as dimension Y.

Each of the subpixels further includes an organic EL media 110. There are numerous configurations of the organic EL media 110 layers wherein the present invention can be successfully practiced. For the organic EL media, a broadband or white light source, which emits light at the wavelengths used by all the subpixels, may be used to avoid the need for patterning the organic EL media between subpixels. In this case, color filters (not shown) may be provided for some of the subpixels in the path of the light to produce the desired light colors from the white or broadband emission for a multi-color display. Some examples of organic EL media layers that emit broadband or white light are described, for example, in U.S. Pat. No. 6696177B1. However, the present invention can also be made to work where each subpixel has one or more of the organic EL media layers separately patterned for each subpixel to emit differing colors for specific subpixels. The organic EL media 110 is constructed of several layers such as; a hole injecting layer 122, a hole transporting layer 124 that is disposed over the hole injecting layer 122, a light-emitting layer 126 disposed over the hole transporting layer 124, and an electron transporting layer 128 disposed over the light-emitting layer 126. Alternate constructions of the organic EL media 110 having fewer or more layers can also be used to successfully practice the present invention. These organic EL media layers are typically comprised of organic materials, either small molecule or polymer materials, as is known in the art. These organic EL media layers can be deposited by several methods known in the art such as, for example, thermal evaporation in a vacuum chamber, laser transfer from a donor substrate, or deposition from a solvent by use of an ink jet print apparatus.

Above the organic EL media 110, a second electrode 130 is formed. For a bottom emitting device, this electrode is preferably highly reflective and may be composed of a metal such as aluminum or silver or magnesium silver alloy. The second electrode may also comprise an electron injecting layer (not shown) composed of a material such as lithium to aid in the injection of electrons. When stimulated by an electrical current between first electrode 96 and second electrode 130, the organic EL media 110 produces light emission 132.

Most OLED devices are sensitive to moisture or oxygen, or both, so they are commonly sealed in an inert atmosphere such as nitrogen or argon, along with a desiccant such as alumina, bauxite, calcium sulfate, clays, silica gel, zeolites, alkaline metal oxides, alkaline earth metal oxides, sulfates, or metal halides and perchlorates. Methods for encapsulation and desiccation include, but are not limited to, those described in U.S. Pat. No. 6,226,890. In addition, barrier layers such as SiOx, Teflon, and alternating inorganic/polymeric layers are known in the art for encapsulation.

OLED devices of this invention can employ various well-known optical effects in order to enhance its properties if desired. This includes but is not limited to optimizing layer thicknesses to yield maximum light transmission, providing dielectric mirror structures, replacing reflective electrodes with light-absorbing electrodes, providing anti-glare or anti-reflection coatings over the display, providing a polarizing media over the display, or providing colored, neutral density, or color conversion filters over the display.

While the embodiments described herein refers to a specific configuration of active matrix drive circuitry and subpixel design, several variations of conventional circuits that are known in the art can also be applied to the present invention by those skilled in the art. For example, one variation in U.S. Pat. No. 5,550,066 connects the capacitors directly to the power line instead of a separate capacitor line. A variation in U.S. Pat. No. 6,476,419 uses two capacitors disposed directly over one and another, wherein the first capacitor is fabricated between the semiconductor layer and the gate conductor layer that forms gate conductor, and the second capacitor is fabricated between the gate conductor layer and the second conductor layer that forms power lines and data lines.

While the drive circuitry described herein requires a select transistor and a power transistor, several variations of these transistor designs are known in the art. For example, single- and multi-gate versions of transistors are known and have been applied to select transistors in prior art. A single-gate transistor includes a gate, a source and a drain. An example of the use of a single-gate type of transistor for the select transistor is shown in U.S. Pat. No. 6,429,599. A multi-gate transistor includes at least two gates electrically connected together and therefore a source, a drain, and at least one intermediate source-drain between the gates. An example of the use of a multi-gate type of transistor for the select transistor is shown in U.S. Pat. No. 6,476,419. This type of transistor can be represented in a circuit schematic by a single transistor or by two or more transistors in series in which the gates are connected and the source of one transistor is connected directly to the drain of the next transistor. While the performance of these designs can differ, both types of transistors serve the same function in the circuit and either type can be applied to the present invention by those skilled in the art. The example of the preferred embodiment of the present invention is shown with a multi-gate type select transistor 84 which is represented by a single transistor symbol in the circuit schematic diagrams FIG. 6.

Also known in the art is the use multiple parallel transistors, which are typically applied to power transistor 106. Multiple parallel transistors are described in U.S. Pat. No. 6,501,448. Multiple parallel transistors consist of two or more transistors in which their sources connected together, their drains connected together, and their gates connected together. The multiple transistors are separated within the subpixels so as to provide multiple parallel paths for current flow. The use of multiple parallel transistors has the advantage of providing robustness against variability and defects in the semiconductor layer manufacturing process. While the power transistors described in the various embodiments of the present invention are shown as single transistors, multiple parallel transistors can be used by those skilled in the art and are understood to be within the spirit of the invention.

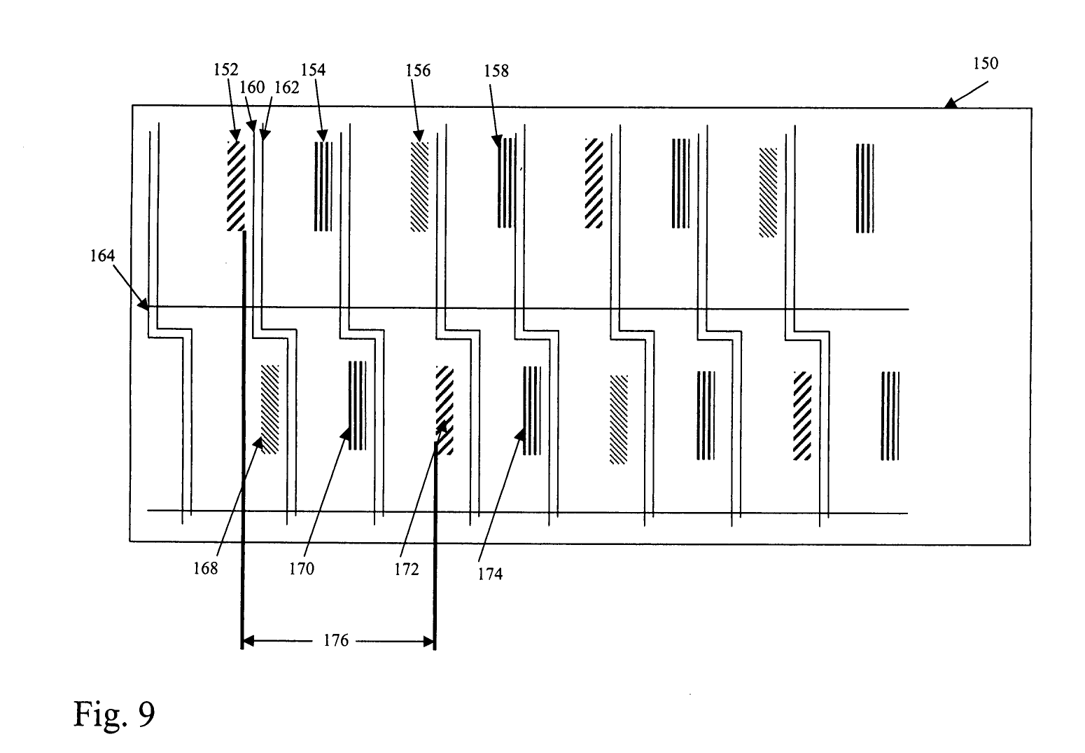

Turning again to other pixel patterns that are designed for application within any known display technology, another method for reducing the maximum of the vertical and horizontal spacing between subpixels within the red and blue channels is to shift rows or columns of pixels in order to reduce the gap between neighboring red or blue subpixels, as shown in FIG. 9. This figure shows a portion of a display device 150. As shown in this figure, each row of subpixels consists of some number of lower luminance (e.g., red 152 and 172, as well as blue 156 and 168) subpixels and a larger number of higher luminance subpixels (e.g., green 154, 158, 170 and 174). Subpixels in adjacent rows, however, are shifted such that the maximum distance between the lower luminance subpixels of any color is reduced as compared to the pixel pattern shown in FIG. 3. As shown in this figure, the second row of subpixels is shifted with respect to the first row such that the successive row starts with a blue subpixel 168, which is aligned between the red 152 and first green 154 subpixels in the first row. This blue subpixel 168 is followed by a green 170, red 172 and a second green 174 subpixel. By shifting the position of successive rows on the display panel the maximum horizontal distance 176 between neighboring lower luminance color subpixels of a given color may be reduced as compared to the stripe pattern of the prior art, while high luminance green subpixels in adjacent rows are maintained in a relatively more perpendicular alignment than are each of the lower luminance color red and blue subpixels. This fact allows the display device to appear more uniform when displaying lower luminance colors, while minimizing the appearance of “jagged” vertical lines within text characters and other high-contrast, vertically-oriented edges.

Within the particular layout of FIG. 9, the subpixels are not arranged within a rectangular grid and therefore the drive 160 and power 162 lines are not straight while the select line 164 is straight. Note that while red and blue subpixels would typically have separate drive and, if necessary, power lines they share drive 160 and power 162 lines within this embodiment. This embodiment provides the distinct advantage of decreasing the number of necessary lines, decreasing the amount of space necessary for electronics and increasing the fill factor of the subpixels. It is, however, possible that separate drive 160 and, if necessary, power lines 162 be provided to drive the red and blue subpixels. As discussed before, the fact that red and blue subpixels share drive lines 160, requires that the red and blue signal be phased such that the red and blue drive signals are alternated as red and blue subpixels are selected. This may require slightly more processing in an asic that is required to drive the display device. However, the fact that the red and blue subpixels share a drive line 160 also allows the asic to provide only two channels of analog output, which will reduce the complexity of the asic and potentially reduce the power required to drive it.

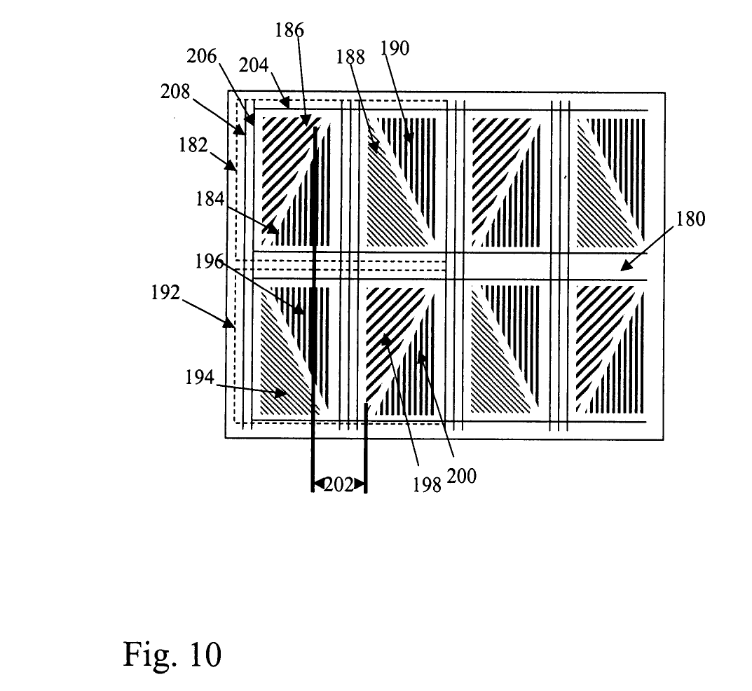

Each of the embodiments shown has used rectilinear shaped subpixels. However, this is not required, and, in fact, the effective distance between neighboring subpixels of a single color may be reduced through the use of non-rectilinear shaped subpixels. This is especially useful in displays with large fill factors. One such pixel pattern is shown within a small portion of the display device 180 in FIG. 10. In such Figure, a first row of pixels in the display is depicted which comprise a first pixel type wherein the subpixels are positioned in a sequence of red, green, blue and green triangular shaped subpixels, the sequence of subpixels in the row of pixels repeating across the width of the display, and a second row of pixels in the display comprise a second pixel type wherein the subpixels are positioned in a sequence of blue, green, red and green triangular shaped subpixels, the sequence of subpixels in the row of pixels repeating across the width of the display. As with previous embodiments, the depicted rows of pixels would alternate across the height of the display. As further shown in this figure, the display device is formed from pixels 182 and 192 that have at least two different layouts. The first pixel 182 is configured from a series of triangular shaped subpixels, wherein a pair of two triangles form a rectangle. Each rectangle is formed from pixels from a lower luminance channel (e.g., red or blue) while the accompanying triangle is formed from pixels from the higher luminance channel (e.g., green). In FIG. 10, the top left corner of the first rectangle is formed from a red, triangularly-shaped subpixel 186 while the bottom right of the subpixel is formed from a green, triangularly-shaped subpixel 184. The second rectangle in the pixel 182 is formed from a blue, triangularly shaped subpixel 188 in the bottom left and a green, rectangularly-shaped subpixel 190 in the top right. The pixel 192 with the second layout moves the blue subpixel into the first rectangle thereof and the red subpixel into the second rectangle, such that the layout of the second pixel 192 consists of a blue, triangularly-shaped subpixel 194 in the lower left of the first rectangle and a green, triangularly-shaped subpixel 196 in the top right of the first rectangle, while a red, triangularly-shaped subpixel 198 is positioned in the top left of the second rectangle and a green, triangularly-shaped subpixel 200 is positioned at the bottom right of the second rectangle.

By arranging these subpixels as shown in FIG. 10, the maximum of the horizontal and vertical distance 202 between the subsampled, lower luminance subpixels may be minimized. Although many pixel patterns with non-rectilinear subpixels may be drawn that meet the requirements of the present invention, this pattern is particularly desirable since it has the additional benefit that the higher luminance pixels can be turned on to form diagonal edges, which can help to reduce the jagged edge effect that is often seen when displaying high contrast edges on display devices that employ rectangular pixels.

It should further be noted that by applying this arrangement of triangularly-shaped subpixels that the red and blue subpixels can once again share data and power lines, thereby providing the advantages of the pattern shown in FIG. 4. These advantages include the use of only ⅔rds as many data and power lines. They also include the fact that the signal processor used to drive the display is only required to have two analog output channels.

While it is not necessary that pairs of subpixels form a rectangle, the fact that each pair of triangles in FIG. 10 do form a rectangle allows the select 204, data 206 and power 208 lines to pass through the pixel array while lying on a rectilinear grid. Alternatively, the triangles could be formed from a series of interlocking triangles. One such interlocking triangular arrangement could include an upright equilateral triangle with a neighboring, upside down equilateral triangle. While such an interlocking triangular arrangement will not provide a rectilinear grid to allow select 204, data 206, and power 208 lines to pass through the pixel, this requirement is not relevant to all display panels. For instance, it is known in the art to place the electronics in a layer underneath a top emitting OLED. Therefore, such a pixel arrangement may provide an advantaged layout in such a display device.

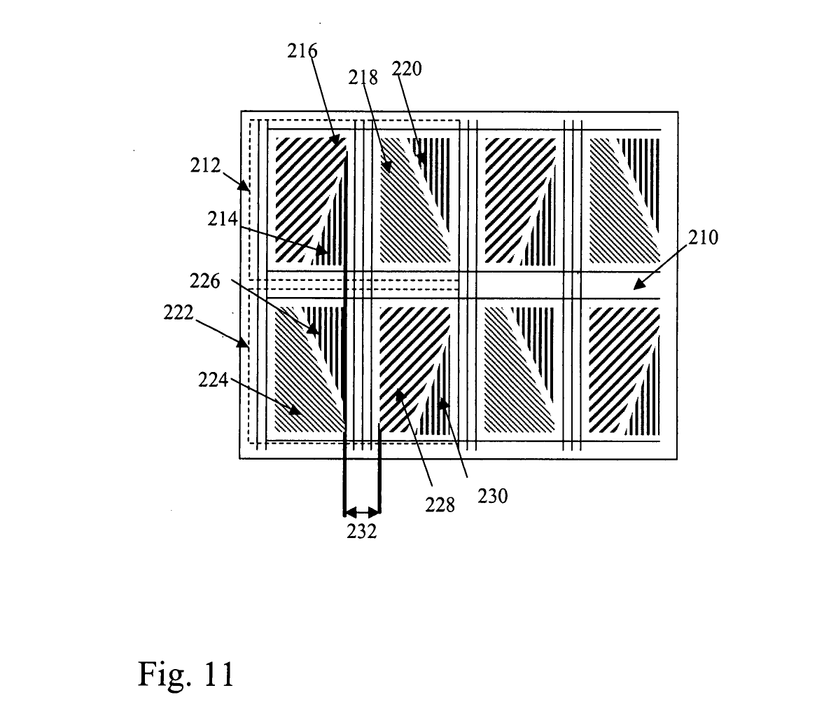

It should also be noted, that the rectangular arrangement that is formed from pairs of triangles can be maintained even when different sized, red, green and blue subpixels are required. FIG. 11 shows a display device 210 in which the sizes and shapes of the subpixels from FIG. 10 have been resized in pixels 212 and 222. To accomplish this resizing, the red 216 and 228, as well as the blue subpixels 218 and 224, are shown as larger area, five-sided polygons while the size of the green triangularly-shaped subpixels 214, 220, 226, and 230 has been reduced. However, the same general pixel layout is maintained, as is the rectangular layout of each subpixel pair. Notice once again that by using pixels with two different subpixel layouts, the maximum of the horizontal and vertical distance 232 between subpixels is minimized.

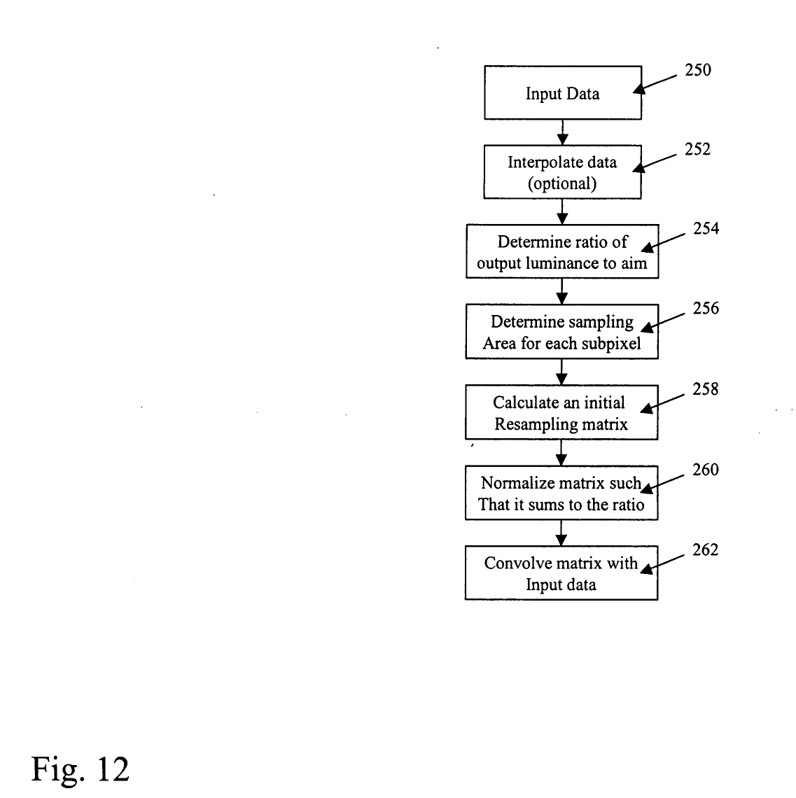

Having a display device with these pixel patterns, the input three-color data stream that is input into a display device must be converted to a signal capable of driving such a display device. Such a rendering method is dependent upon numerous parameters. FIG. 12 shows one embodiment of such a rendering method. In this method, it will be assumed that the incoming data stream input 250 into the display device has data for spatially co-incident red, green, and blue subpixels for each pixel. To provide the highest quality image, the input signal will have data for each green subpixel in the display. Therefore, the input signal will contain more information in the two lower luminance red and blue channels than the display has red and blue subpixels. If the input signal is lower or higher in resolution than the number of green subpixels, a standard interpolation can be performed 252 on the input data to provide a data stream that has data to derive each of the green subpixels within the display device.

Before processing the data, one will determine 254 the ratio of the output luminance for each of the color channels to the luminance required from each channel to form the white point of the display device. Depending upon the technology of the display device, this ratio may be affected by a number of factors. For instance, in an LCD, the relative area of each liquid crystal element, the color filter and/or the spectrum of the backlight can affect the output luminance of each color channel when spatially integrated across several pixels. In emissive devices, such as OLEDs, the drive current, the size of the emitter, the spectrum of the emitter, and/or the spectrum of any color filter that is applied may affect this same ratio. However, in a preferred embodiment, this ratio will be unity. Calculating or measuring the average luminance of each color channel at its maximum drive value may determine this value. This value is used as a numerator and the denominator is determined by calculating the luminance required from each color channel to form the desired display white point.

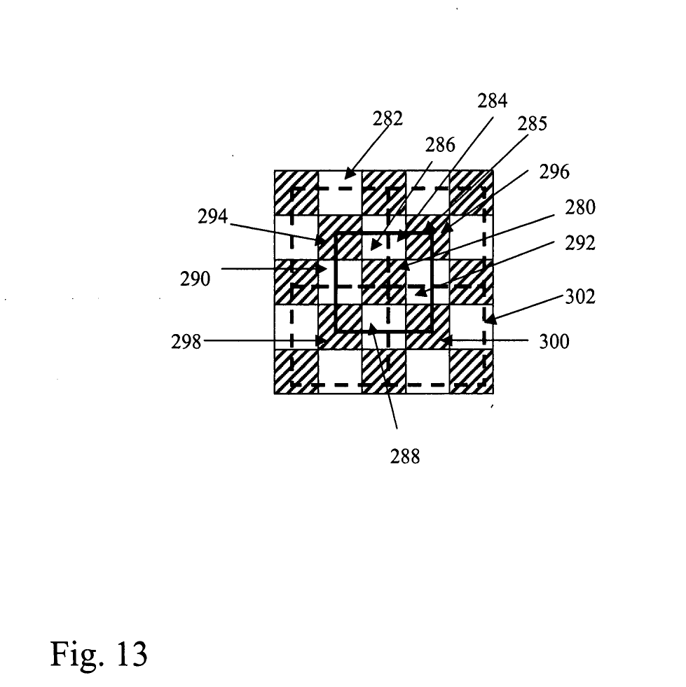

Following this step, the sampling area will be determined 256 for each subpixel on the display. Since the image resolution is sampled to the same number of data locations as the display device has higher luminance (e.g., green) subpixels, each green subpixel will typically represent the same area as the input image data. However, each lower luminance (e.g., red and blue) subpixel will typically represent a larger area in the original input since there are fewer of these subpixels. FIG. 13 shows a two-dimensional representation of data locations wherein each of the small squares represent a data location in the input image. As the sampling array of the display device is overlaid upon this representation, red and blue subpixels will be present within some data locations but not in others. In FIG. 13, the shaded regions represent the data locations that correspond to the location of a subpixel of the first of the sub-sampled, lower luminance colors when the lower-luminance subpixels from the pixel pattern shown in FIG. 4 are overlaid on the representation of the incoming data stream. The non-shaded regions, such as 282, represent data locations that correspond to the spatial location of the second of the sub-sampled, lower luminance colors. Since the lower-luminance colors are sub-sampled, there are no corresponding subpixels of the first color of the sub-sampled, lower luminance subpixels at the location of the non-shaded data locations. The sampling area 284 for the center subpixel 280 in FIG. 4 is indicated by the boundary 285. Generally, the sampling area will be centered near the center of gravity of the subpixel. As shown, this sampling area includes the data location where the subpixel is located, half of the data locations directly above 286, below 288, to the left 290 and to the right 292 of the subpixel location 280. It further contains one fourth of the area of the data locations to the top left 294, top right 296, bottom left 298 and bottom right 300 of the current subpixel location 280.

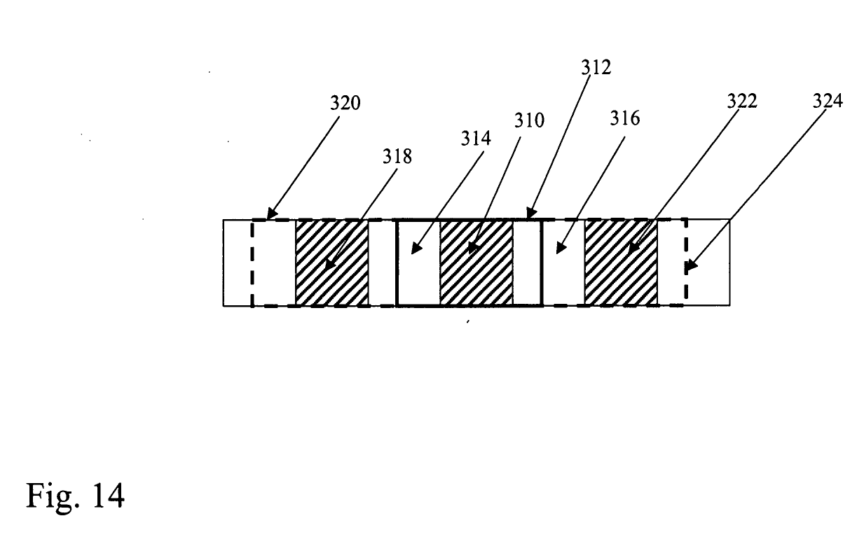

While the previous discussion showed a two-dimensional sampling area, subsequent image processing steps may be simplified if the sampling area is thought of in a single dimension. FIG. 14 shows the sampling area when only one dimensional resampling is considered. In this figure, the location of a subpixel to be resampled 310 is represented in a portion of a row of input data. The sampling area for this subpixel includes the data location 312 where the subpixel is located, as well as half of the data location to the left 314 and half of the data location to the right 316.

This sampling area is used as an input to calculate 258 an initial resampling matrix. This resampling matrix is typically defined such that the denominator of entries in this matrix are a function of the area of each input pixel that lies within the sampling area. For example, the two matrices as shown below can be formed by simply taking the inverse of the area of each input data location that lies within the sampling area for the two-dimensional resampling matrix as well as the one-dimensional resampling matrix.

Two-dimensional matrix

| | | |
|---|---|---|
| 0.25 | 0.5 | 0.25 |
| 0.5 | 1.0 | 0.5 |
| 0.25 | 0.5 | 0.25 |

One-Dimensional Matrix

| | | |
|---|---|---|
| 0.5 | 1.0 | 0.5 |

In this example, each entry in these matrices represents the proportion of each data location that lies within the sampling area. While other approaches may be used to create these matrices, these values will be a function of the proportion of each data location that lies within the sampling area.

These matrices are then normalized 260 such that the sums of the matrix elements are equal to the ratio of the output luminance for each of the color channels to the luminance required from each channel to form the white point of the display device as defined in step 254. Assuming that this ratio is 1.0 for the target display, the final matrices are formed with the values shown as:

Two-dimensional matrix

| | | |
|---|---|---|
| 0.0625 | 0.125 | 0.0625 |
| 0.125 | 0.25 | 0.125 |
| 0.0625 | 0.125 | 0.0625 |

One-Dimensional Matrix

| | | |
|---|---|---|
| 0.25 | 0.5 | 0.25 |

These matrices are then convolved 262 with the input signal, which, ideally, will be expressed in a metric that is linearly related to the desired luminance output of the display device. Those skilled in the art will recognize that this process is a prefiltering process that is well known in the art as digital prefiltering, a process that is applied when downsampling a digital image to a lower resolution digital image to avoid aliasing as discussed by W. K. Pratt in Digital Image Processing, John Wiley and Sons, New York, 1978 on pages 104-111. Those skilled in the art will recognize the matrices as filter kernels. For the pixel patterns shown in FIGS. 4, 5, 6, 9, and 10, these matrices will be convolved with the input data for the appropriate data locations in the red channel to obtain the output value for the first lower luminance subpixel and the blue channel to obtain output value for the second lower luminance subpixel. This alternating of red and blue will continue for each column of red and blue subpixels within the display device. For each value, the green channel value in the input signal will be adopted as the output value for the higher luminance subpixel. By alternating the blue and red values and selecting the green values, a matrix of subpixel code values can be formed that are consistent with the layout of the subpixels on the display. The resulting values are then converted to drive voltage values and sent to the display device. In the case where the matrix is a two-dimensional matrix, the processor must store input code values for multiple rows of pixels in order to provide the data necessary for the convolution. Using a single dimension matrix, only a few values need to be buffered, which simplifies the requirements for the processor.

This same approach may be applied for each pattern of subpixels disclosed herein. However, the preferred matrices will be different for each of the remaining subpixel patterns. Other simpler approaches may be applied. For example, a single interpolation step may be performed in which the green channel is interpolated to the number of green subpixels while the red and blue channels are interpolated to the number of red and blue subpixels. The resulting values may then be used to directly drive the display device. It may also be noted that the resampling implemented as steps 256 through 262 in FIG. 12 may be designed to eliminate certain sampling artifacts. Another advantage of the pixel patterns of certain embodiments of the current invention is that since the resulting red and blue subpixels sample the pattern in a regular grid without significant gaps, many of the sampling artifacts that occur with the subsampled patterns known in the prior art are less visible when applying the pixel patterns of the current invention. Therefore steps 256 through 262 may be foregone without a significant reduction in image quality when rendering many types of images by applying the pixel patterns of the current invention.

The invention has been described in detail with particular reference to certain preferred embodiments thereof, but it will be understood that variations and modifications can be effected within the spirit and scope of the invention.

### PARTS LIST

2 display device
4 pixel
6 red subpixel
8 green subpixel
10 blue subpixel
12 select line
14 data line
16 power line
20 display device
22 pixel
24 red subpixel
26 green subpixel
28 green subpixel
30 blue subpixel
32 largest of the horizontal or vertical separation
34 display device
36 pixel
38 red subpixel
40 green subpixel
42 blue subpixel
44 green subpixel
46 select line
48 data lines
50 power lines
52 horizontal separation
54 display device
56 pixel
58 red subpixel
60 green subpixel
62 blue subpixel
64 green subpixel
66 array of subpixels
68 blue subpixel
70 green subpixel
72 red subpixel
73 maximum of horizontal and vertical distance
74 green subpixel
76, 76a, 76b select line
78, 78a, 78b capacitor line
80 data line
82 power line
84 select transistor
86 storage capacitor
88 power transistor
90 organic light emitting diode
92 first semiconductor region
94 second semiconductor region
96 first electrode
98 via
100 via
102 via
104 via
106 power transistor
108 power transistor gate
110 EL media
112 substrate
114 first dielectric layer
116 second dielectric layer
118 third dielectric layer
120 inter-subpixel dielectric
122 hole injecting layer
124 hole transporting layer
126 light emitting layer
128 electron transporting layer
130 second electrode
132 light emission
150 display device
152 red subpixel in first row
154 first green subpixel in first row
156 blue subpixel in first row
158 second green subpixel in first row
160 drive line
162 power line
164 select line
168 blue subpixel in second row
170 first green subpixel in second row
172 red subpixel in second row
174 second green subpixel in second row
176 maximum horizontal or vertical distance
180 display device
182 pixel
184 green, triangularly-shaped subpixel
186 red, triangularly-shaped subpixel
188 blue, triangularly-shaped subpixel
190 green, triangularly-shaped subpixel
192 pixel
194 blue, triangularly-shaped subpixel
196 green, triangularly-shaped subpixel
198 red, triangularly-shaped subpixel
200 green, triangularly-shaped subpixel
202 maximum of the horizontal and vertical distance
204 select line
206 data line
208 power line
210 display device
212 pixel
214 green, triangularly-shaped subpixel
216 red subpixel
218 blue subpixel
220 green triangularly-shaped subpixel
222 pixel
224 blue subpixel
226 green triangularly-shaped subpixel
228 red subpixel
230 green, triangularly-shaped subpixel
232 maximum of the horizontal and vertical distance
250 input data stream step
252 perform interpolation step
254 determine ratio step
256 determine sampling area step
258 determine initial resampling matrix step
260 normalize to the ratio of the output luminance step
262 convolve with input signal step
280 subpixel location
282 data locations without a subpixel
284 sampling region
285 boundary
286 subpixel above subpixel location 280
288 subpixel below subpixel location 280
290 subpixel left of the subpixel location 280
292 subpixel to the right of the subpixel location 280
294 subpixel to the top left of the subpixel location 280
296 subpixel to the top right of the subpixel location 280
298 subpixel to the bottom left of the subpixel location 280
300 subpixel to the bottom right of the subpixel location 280
302 sampling region for surrounding subpixels
310 sampling region of current subpixel
312 data location of subpixel
314 half of the data location to the left
316 half of the data location to the right
318 neighboring subpixel
320 sampling region of neighboring subpixel
322 neighboring subpixel
324 sampling region of neighboring subpixel

What is claimed is:

1. A color display device, comprising:
an array of subpixels of three different colors, including subpixels of a relatively high luminance first color and subpixels of relatively lower luminance second and third colors,
wherein the subpixels are arranged into rows or columns to form a repeating pattern of alternating lower luminance and high luminance color subpixels in each row or column, with the sequential order of the two lower luminance color subpixels being alternated within each row or column, and wherein the alignment of subpixels of the same colors in adjacent rows or columns is such that the high luminance color subpixels are aligned more closely to perpendicular than are each of the lower luminance color subpixels relative to the direction of the rows or columns in which the subpixels are arranged in a repeating pattern.

2. A display device of claim 1, wherein the relatively high luminance color subpixels are green in color.

3. A display device of claim 1, wherein the relatively lower luminance color subpixels are blue and red subpixels.

4. A display device of claim 1, wherein the subpixels are arranged into rows to form a repeating pattern, and columns of subpixels are perpendicularly offset from one another.

5. A display device of claim 1, wherein the subpixels are arranged into horizontal rows to form a repeating pattern, and columns of the high luminance color subpixels are perpendicularly aligned in the vertical direction.

6. A display device of claim 1, wherein the subpixels of at least one color are different in area than the subpixels of another color.

7. A display device of claim 1, wherein the subpixels of at least one relatively lower luminance color are greater in area than the relatively high luminance color subpixels.

8. A display device according to claim 1, wherein:
alternating horizontal rows of pixels in the display comprise a first pixel type wherein the subpixels are positioned in a sequence of relatively lower luminance second color, relatively high luminance first color, relatively lower luminance third color, and relatively high luminance first color subpixels, said sequence of subpixels in said alternating rows of pixels repeating across the width of the display; and
interleaving horizontal rows of pixels between the alternating rows in the display comprise a second pixel type wherein the subpixels are positioned in a sequence of relatively lower luminance third color, relatively high luminance first color, relatively lower luminance second color, and relatively high luminance first color subpixels, said sequence of subpixels in said interleaving rows of pixels repeating across the width of the display; and
said sequences of subpixels in alternating and interleaving rows repeating across the height of the display.

9. A display device according to claim 8, wherein:
the alternating horizontal rows of pixels in the display comprise a first pixel type wherein the subpixels are positioned in a sequence of red, green, blue and green rectangular shaped subpixels, whose long axes are oriented vertically, and whose long axes are parallel to each other, said sequence of subpixels in said alternating rows of pixels repeating across the width of the display; and
the interleaving horizontal rows of pixels between the alternating rows in the display comprise a second pixel type wherein the subpixels are positioned in a sequence of blue, green, red and green rectangular shaped subpixels, whose long axes are oriented vertically, and whose long axes are parallel to each other, said sequence of subpixels in said interleaving rows of pixels repeating across the width of the display.

10. The color display device of claim 9, wherein at least one of the red and blue subpixels are wider than the green subpixels.

11. The color display device of claim 9, wherein at least one of the red and blue subpixels are taller than the other of the red and blue subpixels.

12. A color display device of claim 8, wherein
the alternating rows of pixels in the display comprise a first pixel type wherein the subpixels are positioned in a sequence of red, green, blue and green triangular shaped subpixels, said sequence of subpixels in said alternating rows of pixels repeating across the width of the display; and
the interleaving rows of pixels between the alternating rows in the display comprise a second pixel type wherein the subpixels are positioned in a sequence of blue, green, red and green triangular shaped subpixels, said sequence of subpixels in said interleaving rows of pixels repeating across the width of the display.

13. A color display device of claim 1, wherein the subpixels of at least one of the colors are not rectangular shaped.

14. A color display device of claim 1, wherein the subpixels of at least one of the colors are triangular in shape.

15. A color display device of claim 1, wherein pairs of subpixels of two different colors form a rectangular shape.

16. A display device of claim 1, wherein the display device comprises a Liquid Crystal device.

17. A color display device of claim 1, wherein a three-color signal is input to the display device and wherein the signal that is used to drive the two relatively lower luminance color subpixels is resampled.

18. The color display device of claim 17, wherein the resampling includes the convolution of a matrix with the input signal for the two relatively-lower luminance color subpixels.

19. The color display device of claim 17, wherein resampling includes the steps of:
a) determining the ratio of the output luminance of each colored-subpixel to its aim luminance,
b) determining the sampling area for each subpixel,
c) calculating an initial resampling matrix, and
d) normalizing the matrix such that it sums to the ratio of the output luminance of each colored subpixel to its aim luminance.

20. The color display device of claim 1, wherein the relatively lower luminance color subpixels are aligned in columns and share data and/or power lines.

21. The color display device of claim 1, wherein two rows of pixels are disposed between neighboring select lines.

22. The color display device of claim 1, wherein the display device is an OLED display device.

23. The color display device of claim 22, wherein at least two different color subpixels are formed from different light emitting materials.

24. The color display device of claim 22, wherein at least two different color subpixels are formed through the use of color filters.

25. The color display device of claim 1, further comprising a processor which accepts a three-color input signal and outputs two analog data channels.

26. The color display device of claim 25, in which one of the output analog data channels provides a signal to drive the two relatively lower luminance color subpixels while the second analog data channel provides a signal to drive the relatively high luminance color subpixel.
